(19) United States
(12) Patent Application Publication
(10) Pub. No.: US 2018/0043722 A1
(43) Pub. Date: Feb. 15, 2018

(54) PAGE REMEMBERING BOOKMARK

(71) Applicant: Janine Liu, Armonk, NY (US)

(72) Inventor: Janine Liu, Armonk, NY (US)

(21) Appl. No.: 15/477,442

(22) Filed: Apr. 3, 2017

Related U.S. Application Data
(60) Provisional application No. 62/494,503, filed on Aug. 12, 2016.

(51) Int. Cl. B42D 9/00

(52) U.S. Cl. CPC B42D 9/007

(57) ABSTRACT

An apparatus including a bookmark having a first substantially circular disk having digits 1 through 9 and 0; and a member having a first opening to allow one of the digits 1 through 9 and 0 to show through the first opening while the other digits are blocked. The member may have a length, a width, and depth; the depth substantially less than the width and the length. The first substantially circular disk may have a diameter and a thickness, the diameter substantially greater than the thickness of the first substantially circular disk. The bookmark may also include a first attachment device attaching the first substantially circular disk to the member so that the thickness of the first substantially circular disk is parallel to the depth of the member, and the first substantially circular disk can rotate to change which digit shows through the first opening of the member.

### CROSS REFERENCE TO RELATED APPLICATION(S)

The present application claims the priority of U.S. provisional patent application Ser. No. 62/494,503, filed Aug. 12, 2016, titled “Page number remembering bookmark”, inventor Janine Liu.

### FIELD OF THE INVENTION

This invention relates to improved methods and apparatus concerning bookmarks.

### BACKGROUND OF THE INVENTION

Various bookmarks are known. However generally when a bookmark falls out of a book, a person will lose his or her place in the book and may need to start again. There is a need for a device which remembers the book page, even if the book mark falls out of the book.

### SUMMARY OF THE INVENTION

In at least one embodiment, the present invention provides a bookmark with indices assembled on it, which can lead to the readers to the book page of the last reading. The readers may turn the indices assembled on the bookmark to remember the page number at the end of the last reading. In the possibility that the reader's bookmark is accidentally removed or dropped off, one or more embodiments of the current invention are helpful when a person fails to recollect where they left off.

In at least one embodiment, an apparatus is provided which includes a bookmark comprising a first substantially circular disk having digits 1 through 9 and 0 shown on a top surface of the first substantially circular disk; and a member having a first opening configured to allow one of the digits 1 through 9 and 0 on the top surface of the first substantially circular disk to show through the first opening while the other digits of the first substantially circular disk are blocked from being seen by the member.

The member may have a length, a width, and depth, such that the depth is substantially less than the width and the length. The first substantially circular disk may have a diameter and a thickness, wherein the diameter of the first substantially circular disk is substantially greater than the thickness of the first substantially circular disk.

The bookmark may be further comprised of a first attachment device for attaching the first substantially circular disk to the member so that the thickness of the first substantially circular disk is parallel to the depth of the member, and the first substantially circular disk can rotate with respect to the member to change which digit of the digits on the top surface of the first substantially circular disk shows through the first opening of the member.

The apparatus may further include a book having a total thickness based on a number of pages, a front cover, and a back cover. The bookmark may have a total thickness based on the depth of the member, the thickness of the first substantially circular disk, and a thickness added by the attachment device. In at least one embodiment, when the book is closed with the bookmark placed in between pages of the book, and with the total thickness of the bookmark parallel to the total thickness of the book, the bookmark does not substantially add to the total thickness of the book.

In at least one embodiment, the bookmark may be further comprised of a second substantially circular disk having digits 1 through 9 and 0 shown on a top surface of the second substantially circular disk. The member may have a second opening configured to allow one of the digits 1 through 9 and 0 on the top surface of the second substantially circular disk to show through the second opening while the other digits of the second substantially circular disk are blocked from being seen by the member. The second substantially circular disk may have a diameter and a thickness, wherein the diameter of the second substantially circular disk is substantially greater than the thickness of the second substantially circular disk.

The bookmark may further include a second attachment device for attaching the second substantially circular disk to the member so that the thickness of the second substantially circular disk is parallel to the depth of the member, and the second substantially circular disk can rotate with respect to the member to change which digit of the digits on the top surface of the second substantially circular disk shows through the second opening of the member.

The bookmark further include a third substantially circular disk having digits 1 through 9 and 0 shown on a top surface of the third substantially circular disk; wherein the member has a third opening configured to allow one of the digits 1 through 9 and 0 on the top surface of the third substantially circular disk to show through the third opening while the other digits of the third substantially circular disk are blocked from being seen by the member.

The third substantially circular disk may have a diameter and a thickness, wherein the diameter of the third substantially circular disk is substantially greater than the thickness of the third substantially circular disk.

The bookmark may further include a third attachment device for attaching the third substantially circular disk to the member so that the thickness of the third substantially circular disk is parallel to the depth of the member, and the third substantially circular disk can rotate with respect to the member to change which digit of the digits on the top surface of the third substantially circular disk shows through the third opening of the member.

In at least one embodiment a method is provide including the steps of inserting a bookmark in between the pages of a book; and closing the book; wherein the bookmark may be as previously described and the book may be as previously described.

### BRIEF DESCRIPTION OF THE DRAWINGS

FIG. 1 shows a top view of a bookmark in accordance with an embodiment of the present invention, with the bookmark of FIG. 1 shown in an assembled state;

FIG. 2 shows a top view of the bookmark of FIG. 1 shown in a disassembled state;

FIG. 3 shows a bottom view of part of the bookmark of FIG. 1; and

FIG. 4 shows a bottom view of the bookmark of FIG. 1.

### DETAILED DESCRIPTION OF THE DRAWINGS

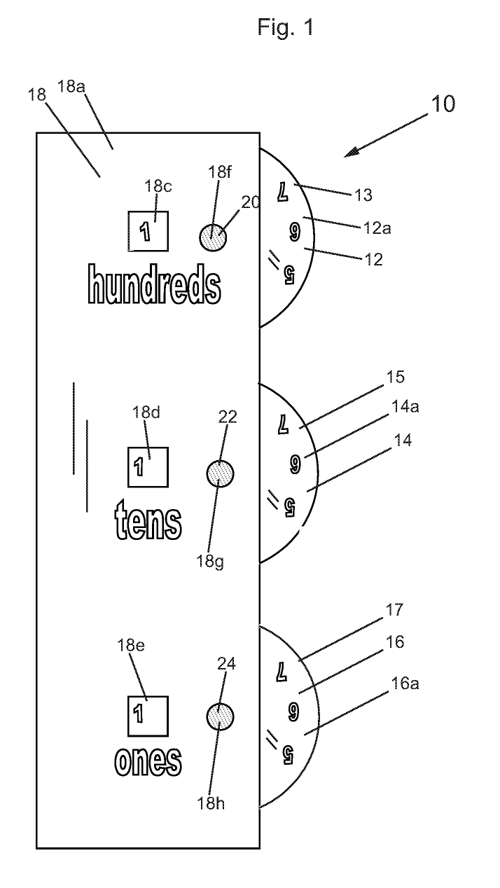

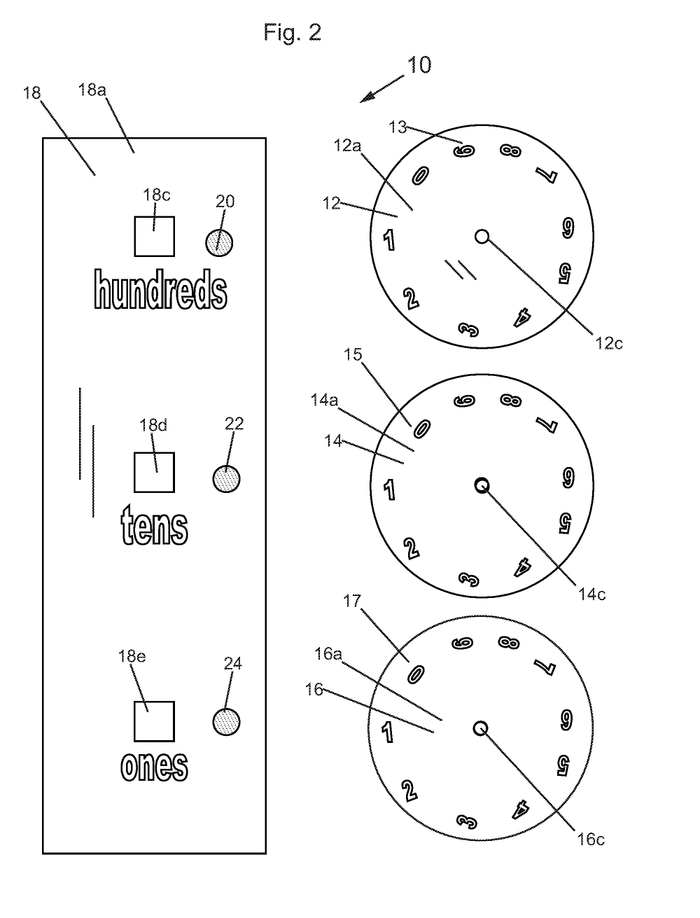

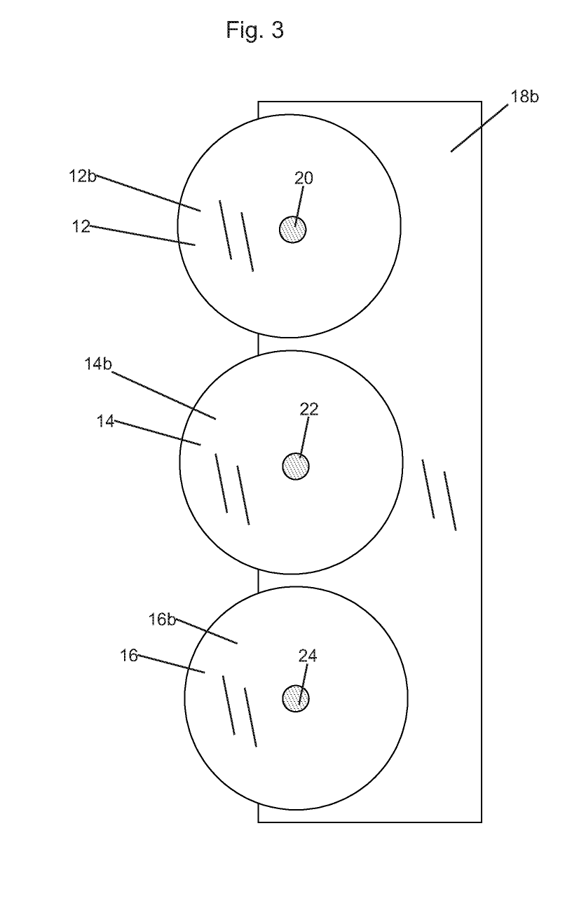

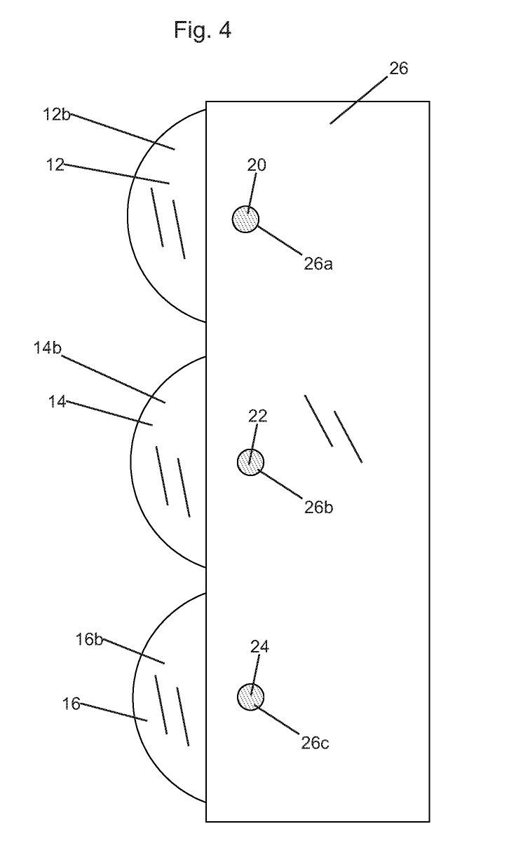

FIG. 1 shows a top view of a bookmark 10 in accordance with an embodiment of the present invention, with the bookmark 10 of FIG. 1 shown in an assembled state. FIG. 2 shows a top view of the bookmark 10 of FIG. 1 shown in a disassembled state. FIG. 3 shows a bottom view of part of the bookmark 10 of FIG. 1. FIG. 4 shows a bottom view of the bookmark 10 of FIG. 1.

The bookmark 10 includes disks or wheels 12, 14, and 16, plate or member 18, pins 20, 22, and 24, shown in FIG. 1, and plate or member 26, shown in FIG. 4.

Referring to FIGS. 2 and 3, the disks or wheels 12, 14, and 16 have top surfaces 12a, 14a, and 16a, rear surfaces 12b, 14b, and 16b, and central openings 12c, 14c, and 16c, respectively.

The pins 20, 22, and 24 may be inserted through the openings 18f, 18g, and 18h in the plate or member 18, shown in FIG. 1, through the openings 12c, 14c, and 16c of the disks 12, 14, and 16, shown in FIG. 2, and through the openings 26a, 26b, and 26c of the member or plate 26, shown in FIG. 4, to thereby fasten or fix the wheels or disks 12, 14, and 16 sandwiched between the plates or members 18 and 26 as in FIG. 1 and FIG. 4.

The disks or wheels 12, 14, and 16 include images of digits or numbers 1, 2, 3, 4, 5, 6, 7, 8, 9, and 0 printed or otherwise fixed on the top surfaces 12a, 14a, and 16a, of the disks or wheels 12, 14, and 16 as shown in FIG. 2.

The member 18 has rectangular openings 18c, 18d, and 18e as shown in FIG. 1 and FIG. 2.

The members 18 and 26, disks 12, 14, and 16 may be make of a flat thin material such as a flat thin paper, cardboard, or plastic. The pins 20, 22, and 24 may be made of metal or of any other suitable fastener material.

When in the assembled form of FIG. 1, the disks 12, 14, and 16 can rotate about pins 20, 22, and 24, respectively, to make one of the digits or numbers 1, 2, 3, 4, 5, 6, 7, 8, 9, and 0 appear through each of the openings 18c, 18d, and 18e. For example, in FIG. 1, the digit 1 appears through opening 18c, the digit 1 appears through opening 18d, and the digit 1 appears through opening 18e. The words “hundreds”, “tens”, and “ones” are shown printed on the surface 18a of the member 18. This signifies that the number appearing through opening 18c indicates hundreds, the number appearing through opening 18d indicates tens, and the number appearing through opening 18e indicates ones, such that the number shown through openings 18c-18e in FIG. 1 is read “111” for page 111 of a book or other reading material.

In at least one embodiment, the function of this bookmark 10 is to indicate to the reader the page number of their last reading. In the possibility that the reader's bookmark is accidentally removed from the page, the page remembering bookmark 10 will be helpful in recollecting the placement of the most recent page number. The adjustable circular indices or wheels 12, 14, and 16 are labelled with numbers 1-9 and 0, allowing the reader to keep track of their page up to page 999.

Three index wheels 12, 14, and 16 are installed on the bookmark body or members 18 and 26 to create three adjustable dials. The three indices 16, 14, and 12, represent ones, tens, and hundreds respectively. The bookmark 10 can track page numbers from 0 to 999; the reader is able to adjust the wheels 12, 14, and 16 by rotating them about their pin 20, 22, and 24, respectively, in accordance with their respective number windows 18c-18e, at the end of the reading period. As an example shown in FIG. 1, the reader turns the index wheels 12, 14, and 16 to label the termination of their last reading at page number 111.

For readers who read books with pages above 999, a bookmark with the fourth index wheel representing thousands may be provided.

Additionally, bookmarks featured with customized designs, colors, and themes may be provided in one or more embodiment. An objective is to create product in which novel functions involving reading are combined with various artistic changes and substitutions without departing from the original scope and spirit of the invention.

The pins 20, 22, and 24 may be or may be replaced by suitable fasteners which may be hardware devices that mechanically affixes two or more objects together.

The index wheels 12, 14, and 16 may be secure enough to not displace page numbers by accidental movements, but will be able to be turned smoothly by the reader.

The number windows 18e, 18d, and 18c reveal the specific ones, tens, and hundreds digits that the reader desires to record. These windows 18e-c are cut into member 18 of the bookmark body. The windows 18e-c should be made to properly indicate only one full digit. Depending on the shape, theme, or design of the bookmark body, including members 18 and 26, the number windows 18e-c can be adjusted accordingly.

Before the readers insert the bookmark 10 into a book to mark a page, the reader turns the index wheels 12, 14, and 16, as desired, to reveal the desired page numbers through the number windows 18e-c.

As an example in FIG. 1, the reader stops reading at page 111 of a book. He turns the index wheels 12, 14, and 16 to show 1 in the number window 18c representing hundreds, 1 in the number window 18d representing tens, and 1 in the number window 18e representing ones.

If the page number is 45, the reader can turn the index wheel 12 to show 0 in the number window 18c representing hundreds, 4 in the number window 18d representing tens, and 5 in the number window 18e representing ones.

If the page number is below 10, e.g. 6, the reader can turn the index wheel 18e representing ones to show 6, and 0 in the number windows 18c and 18d representing hundreds and tens.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising:
a bookmark comprising:
a first substantially circular disk having digits 1 through 9 and 0 shown on a top surface of the first substantially circular disk;
a member having a first opening configured to allow one of the digits 1 through 9 and 0 on the top surface of the first substantially circular disk to show through the first opening while the other digits of the first substantially circular disk are blocked from being seen by the member;
wherein the member has a length, a width, and depth, such that the depth is substantially less than the width and the length;
wherein the first substantially circular disk has a diameter and a thickness, wherein the diameter of the first substantially circular disk is substantially greater than the thickness of the first substantially circular disk;
and wherein the bookmark further comprises a first attachment device for attaching the first substantially circular disk to the member so that the thickness of the first substantially circular disk is parallel to the depth of the member, and the first substantially circular disk can rotate with respect to the member to change which digit of the digits on the top surface of the first substantially circular disk shows through the first opening of the member.

2. The apparatus of claim 1 further comprising
a book having a total thickness based on a number of pages, a front cover, and a back cover;
wherein the bookmark has a total thickness based on the depth of the member, the thickness of the first substantially circular disk, and a thickness added by the attachment device;
and wherein when the book is closed with the bookmark placed in between pages of the book, and with the total thickness of the bookmark parallel to the total thickness of the book, the bookmark does not substantially add to the total thickness of the book.

3. The apparatus of claim 1 wherein
the bookmark further comprises:
a second substantially circular disk having digits 1 through 9 and 0 shown on a top surface of the second substantially circular disk;
wherein the member has a second opening configured to allow one of the digits 1 through 9 and 0 on the top surface of the second substantially circular disk to show through the second opening while the other digits of the second substantially circular disk are blocked from being seen by the member;
wherein the second substantially circular disk has a diameter and a thickness, wherein the diameter of the second substantially circular disk is substantially greater than the thickness of the second substantially circular disk;
and wherein the bookmark further comprises a second attachment device for attaching the second substantially circular disk to the member so that the thickness of the second substantially circular disk is parallel to the depth of the member, and the second substantially circular disk can rotate with respect to the member to change which digit of the digits on the top surface of the second substantially circular disk shows through the second opening of the member.

4. The apparatus of claim 3 wherein
the bookmark further comprises:
a third substantially circular disk having digits 1 through 9 and 0 shown on a top surface of the third substantially circular disk;
wherein the member has a third opening configured to allow one of the digits 1 through 9 and 0 on the top surface of the third substantially circular disk to show through the third opening while the other digits of the third substantially circular disk are blocked from being seen by the member;
wherein the third substantially circular disk has a diameter and a thickness, wherein the diameter of the third substantially circular disk is substantially greater than the thickness of the third substantially circular disk;
and wherein the bookmark further comprises a third attachment device for attaching the third substantially circular disk to the member so that the thickness of the third substantially circular disk is parallel to the depth of the member, and the third substantially circular disk can rotate with respect to the member to change which digit of the digits on the top surface of the third substantially circular disk shows through the third opening of the member.

5. A method comprising the steps of:
inserting a bookmark in between the pages of a book;
closing the book; and
wherein the bookmark comprises:
a first substantially circular disk having digits 1 through 9 and 0 shown on a top surface of the first substantially circular disk;
a member having a first opening configured to allow one of the digits 1 through 9 and 0 on the top surface of the first substantially circular disk to show through the first opening while the other digits of the first substantially circular disk are blocked from being seen by the member;
wherein the member has a length, a width, and depth, such that the depth is substantially less than the width and the length;
wherein the first substantially circular disk has a diameter and a thickness, wherein the diameter of the first substantially circular disk is substantially greater than the thickness of the first substantially circular disk;
and wherein the bookmark further comprises a first attachment device for attaching the first substantially circular disk to the member so that the thickness of the first substantially circular disk is parallel to the depth of the member, and the first substantially circular disk can rotate with respect to the member to change which digit of the digits on the top surface of the first substantially circular disk shows through the first opening of the member.

6. The method of claim 5 wherein
the book has a total thickness based on a number of pages, a front cover, and a back cover;
wherein the bookmark has a total thickness based on the depth of the member, the thickness of the first substantially circular disk, and a thickness added by the attachment device;
and wherein when the book is closed with the bookmark placed in between pages of the book, and with the total thickness of the bookmark parallel to the total thickness of the book, the bookmark does not substantially add to the total thickness of the book.

7. The method of claim 5 wherein
the bookmark further comprises:
a second substantially circular disk having digits 1 through 9 and 0 shown on a top surface of the second substantially circular disk;
wherein the member has a second opening configured to allow one of the digits 1 through 9 and 0 on the top surface of the second substantially circular disk to show through the second opening while the other digits of the second substantially circular disk are blocked from being seen by the member;
wherein the second substantially circular disk has a diameter and a thickness, wherein the diameter of the second substantially circular disk is substantially greater than the thickness of the second substantially circular disk;
and wherein the bookmark further comprises a second attachment device for attaching the second substantially circular disk to the member so that the thickness of the second substantially circular disk is parallel to the depth of the member, and the second substantially circular disk can rotate with respect to the member to change which digit of the digits on the top surface of the second substantially circular disk shows through the second opening of the member.

8. The method of claim 7 wherein
the bookmark further comprises:
a third substantially circular disk having digits 1 through 9 and 0 shown on a top surface of the third substantially circular disk;
wherein the member has a third opening configured to allow one of the digits 1 through 9 and 0 on the top surface of the third substantially circular disk to show through the third opening while the other digits of the third substantially circular disk are blocked from being seen by the member;
wherein the third substantially circular disk has a diameter and a thickness, wherein the diameter of the third substantially circular disk is substantially greater than the thickness of the third substantially circular disk;
and wherein the bookmark further comprises a third attachment device for attaching the third substantially circular disk to the member so that the thickness of the third substantially circular disk is parallel to the depth of the member, and the third substantially circular disk can rotate with respect to the member to change which digit of the digits on the top surface of the third substantially circular disk shows through the third opening of the member.
